(19) United States
(12) Patent Application Publication
(10) Pub. No.: US 2023/0317085 A1
(43) Pub. Date: Oct. 5, 2023

(54) AUDIO PROCESSING DEVICE, AUDIO PROCESSING METHOD, RECORDING MEDIUM, AND AUDIO AUTHENTICATION SYSTEM

(71) Applicant: NEC Corporation, Minato-ku, Tokyo (JP)

(72) Inventor: Hitoshi YAMAMOTO, Tokyo (JP)

(73) Assignee: NEC Corporation, Minato-ku, Tokyo (JP)

(21) Appl. No.: 18/019,126

(22) PCT Filed: Aug. 11, 2020
(86) PCT No.: PCT/JP2020/030542

§ 371 Date: Feb. 1, 2023

(51) Int. Cl. G10L 17/14; G10L 17/02

(52) U.S. Cl. CPC G10L 17/14; G10L 17/02

(57) ABSTRACT

An acoustic feature extraction unit (130) extracts acoustic features indicative of a feature related to speech from audio data. A phoneme classification unit (110) classifies phonemes included in the audio data on the basis of the acoustic features. A first speaker feature calculation unit (140) generates first speaker features indicative of a feature of speech of each phoneme on the basis of acoustic features and phoneme classification information indicative of classification results of the phonemes included in the audio data. A second speaker feature calculation unit (150) generates a second speaker feature indicative of a feature of overall speech by merging first speaker features regarding two or more phonemes.

### TECHNICAL FIELD

The present disclosure relates to an audio processing device, an audio processing method, a recording medium, and an audio authentication system, and more particularly to an audio processing device, an audio processing method, a recording medium, and an audio authentication device that verify a speaker based on audio data input via an input device.

### BACKGROUND ART

In a related technique, a speaker is recognized by verifying voice features (also referred to as acoustic features) included in first audio data with a voice feature included in second audio data. Such a related technique is called an identity confirmation or a speaker verification by voice authentication.

NPL 1 describes that acoustic features extracted from first and second audio data are used as a first input to a deep neural network (DNN), phoneme classification information extracted from phonemes obtained by performing audio recognition on the first and second audio data is used as a second input to the DNN, and a speaker feature for speaker verification are extracted from an intermediate layer of the DNN.

### CITATION LIST

### Non Patent Literature

[NPL 1] Ignatio Vinals et. al., Phonetically aware embeddings, Wide Residual Networks with Time Delay Neural Networks and Self Attention models for the 2018 NIST Speaker Recognition Evaluation″ Interspeech 2019)

### SUMMARY OF INVENTION

### Technical Problem

In the method described in NPL 1, when speakers of the respective pieces of audio data utter partially different phrases between the time of registration of the first audio data and the time of verification of the first and second audio data, there is a high possibility that speaker verification fails. In particular, in a case where the speaker makes a speech while omitting some words/phrases of the speech at the time of registration at the time of verification, there is a possibility that the speaker verification cannot be performed.

The present disclosure has been made in view of the above problems, and an object of the present disclosure is to realize highly accurate speaker verification even in a case where phrases are partially different between pieces of voice data to be compared.

### Solution to Problem

An audio processing device according to an aspect of the present disclosure includes: an acoustic feature extraction means configured to extract acoustic features indicating a feature related to a speech from audio data; a phoneme classification means configured to classify a phoneme included in the audio data based on the acoustic features; a first speaker feature calculation means configured to calculate first speaker features indicating features of a speech for each phoneme based on the acoustic features and phoneme classification information indicating classification results of the phonemes included in the audio data; and a second speaker feature calculation means configured to calculate a second speaker feature indicating a feature of an entire speech by merging the first speaker features for each of two or more phonemes.

An audio processing device according to an aspect of the present disclosure includes: an acoustic feature extraction means configured to extract acoustic features indicating a feature related to a speech from audio data; a phoneme classification means configured to classify a phoneme included in the audio data based on the acoustic features; a phoneme selection means configured to select a phoneme according to a given selection condition among phonemes included in the audio data; and a speaker feature calculation means configured to calculate a speaker feature indicating features of a speech based on the acoustic features, phoneme classification information indicating a verification result of a phoneme included in the audio data, and selection information indicating a phoneme selected according to the given condition.

An audio processing method according to an aspect of the present disclosure includes: extracting acoustic features indicating a feature related to a speech from audio data; classifying a phoneme included in the audio data based on the acoustic features, and generating first speaker features indicating features of a speech for each phoneme based on the acoustic features and phoneme classification information indicating a verification result of a phoneme included in the audio data; and generating a second speaker feature indicating a feature of an entire speech by merging the first speaker features for each of two or more phonemes.

An audio processing method according to an aspect of the present disclosure includes: extracting acoustic features indicating a feature related to a speech from audio data; classifying a phoneme included in the audio data based on the acoustic features; selecting a phoneme according to a given selection condition among phonemes included in the audio data; and generating a speaker feature indicating features of a speech based on the acoustic features, phoneme classification information indicating a verification result of a phoneme included in the audio data, and selection information indicating a phoneme selected according to the given condition.

A recording medium according to an aspect of the present disclosure stores a program for causing a computer to execute: extracting acoustic features indicating features related to a speech from audio data; classifying a phoneme included in the audio data based on the acoustic features; generating first speaker features indicating features of a speech for each phoneme based on the acoustic features and phoneme classification information indicating a verification result of a phoneme included in the audio data; and generating a second speaker feature indicating a feature of an entire speech by merging the first speaker features for each of the two or more phonemes.

A recording medium according to an aspect of the present disclosure stores a program for causing a computer to execute: extracting acoustic features indicating a feature related to a speech from audio data; classifying a phoneme included in the audio data based on the acoustic features; selecting a phoneme according to a given selection condition among phonemes included in the audio data; and generating a speaker feature indicating features of a speech based on the acoustic features, phoneme classification information indicating a verification result of a phoneme included in the audio data, and selection information indicating a phoneme selected according to the given condition.

An audio authentication system according to an aspect of the present disclosure including: the audio processing device according to an aspect of the present disclosure; and a verification device configured to confirm whether a speaker is a registered person himself/herself based on the speaker feature output from the audio processing device.

### Advantageous Effects of Invention

According to an aspect of the present disclosure, even in a case where phrases are partially different between voice data to be compared, highly accurate speaker verification can be realized.

### BRIEF DESCRIPTION OF DRAWINGS

FIG. 1 is a block diagram illustrating a configuration of an audio authentication system common to all example embodiments.

FIG. 2 is a block diagram illustrating a configuration of an audio processing device according to a first example embodiment.

FIG. 3 is a diagram for explaining first speaker features and a second speaker feature output by the audio processing device according to the first example embodiment.

FIG. 4 is a flowchart illustrating an operation of the audio processing device according to the first example embodiment.

FIG. 5 is a block diagram illustrating a configuration of an audio processing device according to a modification of the first example embodiment.

FIG. 6 is a block diagram illustrating a configuration of an audio processing device according to a second example embodiment.

FIG. 7 is a diagram for explaining a speaker feature output by the audio processing device according to the second example embodiment.

FIG. 8 is a flowchart illustrating an operation of the audio processing device according to the second example embodiment.

FIG. 9 is a block diagram illustrating a configuration of an audio processing device according to a third example embodiment.

FIG. 10 is a block diagram illustrating a configuration of an audio processing device according to a fourth example embodiment.

FIG. 11 is a diagram illustrating a hardware configuration of the audio processing device according to any one of the first to fourth example embodiments.

### EXAMPLE EMBODIMENT

### Common to All Example Embodiments

First, an example of a configuration of an audio authentication system commonly applied to the first to fourth example embodiments described later will be described.

### (Audio Authentication System 1)

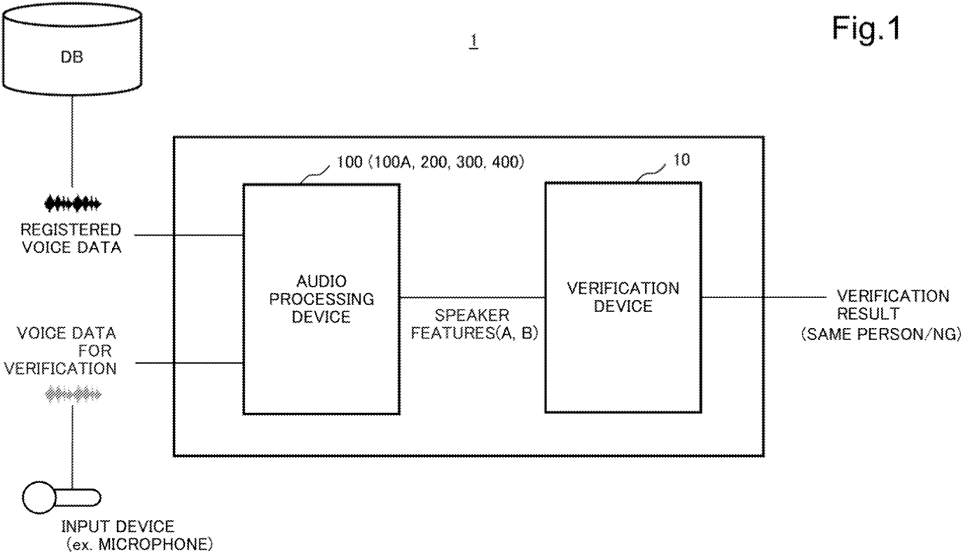

An example of a configuration of an audio authentication system 1 will be described with reference to FIG. 1. FIG. 1 is a block diagram illustrating an example of a configuration of the audio authentication system 1.

As illustrated in FIG. 1, the audio authentication system 1 includes an audio processing device 100 (100A, 200, 300, 400) and a verification device 10 according to any one of the first to fourth example embodiments to be described later. The audio authentication system 1 may include one or more input devices. Here, “Audio processing device 100 (100A, 200, 300, 400)” represents any of the audio processing device 100, the audio processing device 100A, the audio processing device 200, the audio processing device 300, and the audio processing device 400. Processes and operations executed by the audio processing device 100 (100A, 200, 300, 400) will be described in detail in the first to fourth example embodiments described later.

The audio processing device 100 (100A, 200, 300, 400) acquires audio data (hereinafter, it is referred to as registered voice data) of a previously registered speaker (person A) from a data base (DB) on a network or from a DB connected to the audio processing device 100 (100A, 200, 300, 400). The audio processing device 100 (100A, 200, 300, 400) acquires, from the input device, voice data (hereinafter, it is referred to as voice data for verification) of a target (person B) to be compared. The input device is used to input a voice to the audio processing device 100 (100A, 200, 300, 400). In one example, the input device is a microphone for a call or a headset microphone included in a smartphone.

The audio processing device 100 (100A, 200, 300, 400) calculates a speaker feature A for speaker verification based on the registered voice data. The audio processing device 100 (100A, 200, 300, 400) calculates a speaker feature B for speaker verification based on the voice data for verification. A specific method for generating the speaker features A and B will be described in the following first to fourth example embodiments. The audio processing device 100 (100A, 200, 300, 400) transmits the data of the speaker feature A and the speaker feature B to the verification device 10.

The verification device 10 receives data of the speaker feature A and the speaker feature B from the audio processing device 100 (100A, 200, 300, 400). The verification device 10 confirms whether the speaker is the registered person himself/herself based on the speaker feature A and the speaker feature B output from the audio processing device 100 (100A, 200, 300, 400). More specifically, the verification device 10 compares the speaker feature A with the speaker feature B, and outputs an identity confirmation result. That is, the verification device 10 outputs information indicating whether the person A and the person B are the same person.

The audio authentication system 1 may include a control device (control function) that controls an electronic lock of a door for entering an office, automatically activates or logs on an information terminal, or permits access to information on an intra-network on the basis of an identity confirmation result output by the verification device 10.

The audio authentication system 1 may be implemented as a network service. In this case, the audio processing device 100 (100A, 200, 300, 400) and the verification device 10 may be on a network and communicable with one or more input devices via a wireless network.

Hereinafter, a specific example of the audio processing device 100 (100A, 200, 300, 400) included in the audio authentication system 1 will be described. In the following description, “audio data” refers to one or both of the “registered voice data” and the “voice data for verification” described above.

### First Example Embodiment

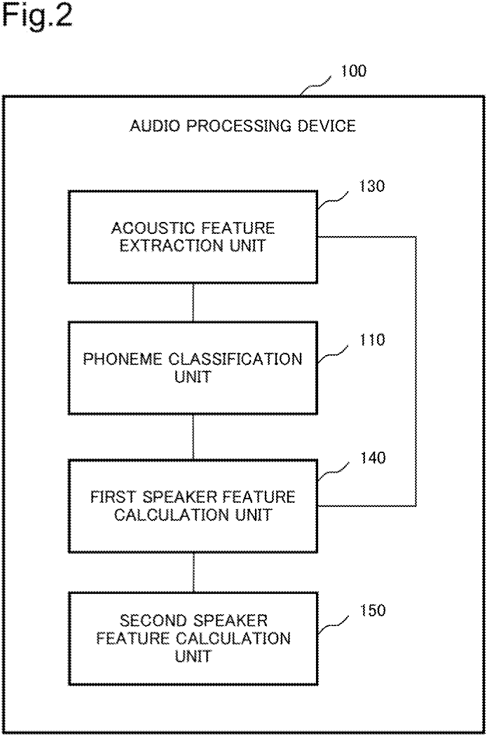

The audio processing device 100 will be described as a first example embodiment with reference to FIGS. 2 to 4.

### (Audio Processing Device 100)

A configuration of the audio processing device 100 according to the present first example embodiment will be described with reference to FIG. 2. FIG. 2 is a block diagram illustrating a configuration of the audio processing device 100. As illustrated in FIG. 2, the audio processing device 100 includes a phoneme classification unit 110, an acoustic feature extraction unit 130, a first speaker feature calculation unit 140, and a second speaker feature calculation unit 150.

The acoustic feature extraction unit 130 extracts acoustic features indicating a feature related to a speech from the audio data. The acoustic feature extraction unit 130 is an example of an acoustic feature extraction means.

In one example, the acoustic feature extraction unit 130 acquires audio data (corresponding to the voice data for verification or the registered voice data in FIG. 1) from the input device.

The acoustic feature extraction unit 130 performs fast Fourier transform on the audio data and then extracts acoustic features from the obtained power spectrum data. The acoustic features are, for example, a formant frequency, a mel-frequency cepstrum coefficient, or a linear predictive coding (LPC) coefficient. It is assumed that each acoustic feature is a N-dimensional vector. In an example, each element of the N-dimensional vector represents the square of the average of the temporal waveform for each frequency bin for a single phoneme (that is, the intensity of the voice), and the number of dimensions N is determined on the basis of the bandwidth of the frequency bin used when the acoustic feature extraction unit 130 extracts the acoustic features from the audio data.

Alternatively, each acoustic feature may be a N-dimensional feature vector (hereinafter, referred to as an acoustic vector) including a feature amount obtained by frequency analysis of audio data. In one example, the acoustic vector indicates a frequency characteristic of audio data input from an input device.

The acoustic feature extraction unit 130 extracts acoustic features of two or more phonemes by the above-described method. The acoustic feature extraction unit 130 outputs the data of the acoustic features extracted from the audio data in this manner to each of the phoneme classification unit 110 and the first speaker feature calculation unit 140.

The phoneme classification unit 110 classifies phonemes included in the audio data on the basis of the acoustic features. The phoneme classification unit 110 is an example of a phoneme classification means. In one example, the phoneme classification unit 110 uses a well-known hidden Markov model or neural network to classify a corresponding phoneme by using data of acoustic features per unit time. Then, the phoneme classification unit 110 combines M likelihoods or posterior probabilities that are the verification results of phonemes to generate an M-dimensional phoneme vector. In one example, M matches the number of phonemes included in a particular language (the language that is assumed to have been spoken), or the number of portions of phonemes (e.g., only vowel sound).

The phoneme classification unit 110 repeats generation of a phoneme vector indicating a single phoneme every unit time as described above. As a result, the phoneme classification unit 110 generates the time-series data (P1, P2, ... PL) of the length L (L is an integer of 2 or more) including the phoneme vector (P1 to PL) indicating the classified phoneme. The time-series data (P1, P2, ... PL) of the length L indicates the phoneme classified by the phoneme classification unit 110. The phoneme vectors (P1 to PL) are hereinafter referred to as phoneme classification information. Each of the phoneme classification information P1 to PL indicates one of n phonemes (n is an integer of 2 or more) in a specific language.

The phoneme classification unit 110 outputs phoneme classification information indicating two or more phonemes classified based on the acoustic features to the first speaker feature calculation unit 140.

The first speaker feature calculation unit 140 receives phoneme classification information indicating two or more classified phonemes from the phoneme classification unit 110. Specifically, the first speaker feature calculation unit 140 receives time-series data (P1, P2, ... PL) having a length L indicating L phonemes classified from the audio data in a specific language (language in which a speech is assumed to have been uttered). The first speaker feature calculation unit 140 receives, from the acoustic feature extraction unit 130, data (F1, F2, ... FL) of acoustic features for two or more phonemes extracted from the audio data.

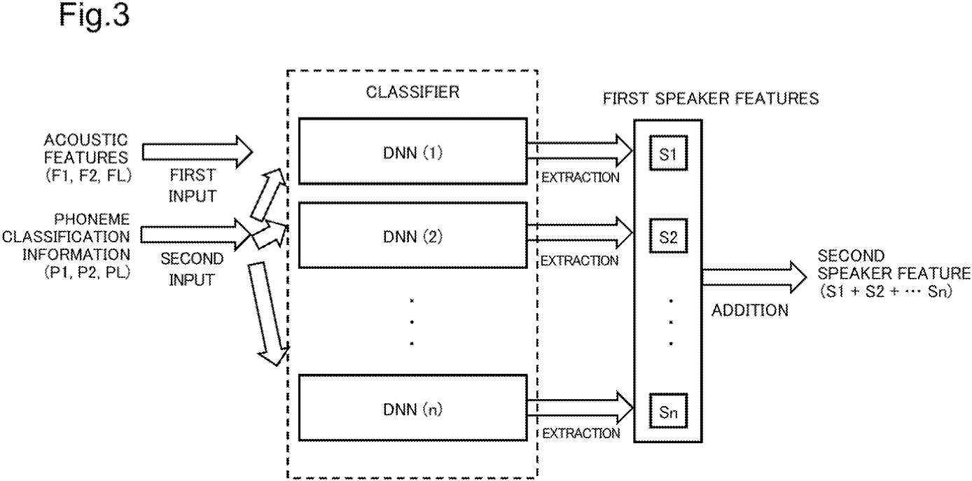

The first speaker feature calculation unit 140 calculates the first speaker features indicating the feature of the speech for each phoneme on the basis of the acoustic features and the phoneme classification information indicating the verification results of the phonemes included in the audio data. The first speaker feature calculation unit 140 is an example of a first speaker feature calculation means. The first speaker features indicate a feature of the speech for each phoneme. A specific example in which the first speaker feature calculation unit 140 calculates the first speaker features using the classifier (FIG. 3) will be described later.

The first speaker feature calculation unit 140 outputs data of the first speaker features calculated for each of two or more phonemes included in the audio data to the second speaker feature calculation unit 150. That is, the first speaker feature calculation unit 140 collectively outputs data of the first speaker features for two or more phonemes to the second speaker feature calculation unit 150.

The second speaker feature calculation unit 150 calculates a second speaker feature indicating a feature of the entire speech by merging first speaker features for two or more phonemes. The second speaker feature calculation unit 150 is an example of a second speaker feature calculation means. The second speaker feature indicates an overall feature of the speaker’s speech. In one example, the sum of the first speaker features for two or more phonemes is the second speaker feature. By using the second speaker feature, even in a case where phrases are partially different between pieces of voice data to be compared, highly accurate speaker verification can be realized. A specific example in which the second speaker feature calculation unit 150 calculates the second speaker feature indicating the feature of the entire speech using the classifier (FIG. 3) will be described later.

The second speaker feature calculation unit 150 outputs the data of the second speaker feature thus calculated to the verification device 10 (FIG. 1). Further, the second speaker feature calculation unit 150 may output the data of the second speaker feature to a device other than the verification device 10.

### (First Speaker Feature and Second Speaker Feature)

FIG. 3 is an explanatory diagram illustrating an outline of processing in which the first speaker feature calculation unit 140 calculates the first speaker features using a classifier, and the second speaker feature calculation unit 150 calculates the second speaker feature indicating a feature of an entire speech. As illustrated in FIG. 3, the classifier includes a deep neural network (DNN) (1) to a DNN (n). As described above, n corresponds to the number of phonemes in a particular language.

Before the phase for generating the first speaker features, the first speaker feature calculation unit 140 completes deep learning of the DNNs (1) to (n) so as to verify the speaker based on the acoustic features (F1, F2, ... FL) that is the first input data and the phoneme classification information (P1, P2, ... PL) that is the second input data.

Specifically, the first speaker feature calculation unit 140 inputs first input data and second input data to the DNNs (1) to (n) in the deep learning phase. For example, a phoneme indicated by the phoneme classification information P1 is a (a is any one of 1 to n). In this case, the first speaker feature calculation unit 140 inputs both the first input data F1 and the second input data P1 to the DNN (a) corresponding to the phonemes among the DNNs (1) to (n). Subsequently, the first speaker feature calculation unit 140 updates each parameter of the DNN (a) so as to bring the output result from the DNN (a) closer to the correct answer of the verification result of the teacher data (that is, to improve the correct answer rate). The first speaker feature calculation unit 140 repeats the process of updating each parameter of the DNN (a) until a predetermined number of times or an index value representing a difference between the output result from the DNN (a) and the correct answer falls below a threshold. This completes the training of the DNN (a). Similarly, the first speaker feature calculation unit 140 trains each of the DNNs (1) to (n).

Subsequently, in a phase for the first speaker feature calculation unit 140 to calculate the first speaker features, the first speaker feature calculation unit 140 inputs acoustic features (any of F1 to FL) as a first input to the trained DNNs (1) to (n) (hereinafter, it is simply referred to as DNNs (1) to (n)), and inputs the phoneme classification information (any of P1 to Pn) extracted from a single phoneme as a second input.

In one example, the acoustic feature F is an N-dimensional feature vector, and the phoneme classification information (P1, P2, ... PL) is an M-dimensional feature vector. The N-dimension and the M-dimension may be the same or different. In this case, the first speaker feature calculation unit 140 combines the acoustic feature F and one piece of phoneme classification information (one of P1 to PL), and the obtained M + N dimensional feature vector is input to one DNN (b) corresponding to a phoneme (here, b) pointed by one piece of phoneme classification information (one of P1 to PL) among DNNs (1) to (n). Here, the combination means that the dimension of the acoustic feature F, which is an N-dimensional feature vector, is extended by M, and the element of the phoneme classification information P, which is an M-dimensional feature vector, is set as a blank M-dimensional element in the M + N dimensional acoustic feature F′.

The first speaker feature calculation unit 140 extracts the first speaker features from the intermediate layer of the DNN (b). Similarly, the first speaker feature calculation unit 140 extracts feature for each set ((P1, F1) to (PL, FL)) of the first input data and the second input data. The feature extracted from the intermediate layers of the DNNs (1) to (n) in this manner are hereinafter referred to as first speaker features (S1, S2, ... Sn) (initial values are 0 or zero vectors). However, when two or more sets of the first input data and the second input data are input to the same DNN (m) (m is any one of 1 to n), the first speaker feature calculation unit 140 sets a feature extracted from an intermediate layer (for example, a pooling layer) of the DNN (m) at the time of initial input as a first speaker feature Sm. Alternatively, the first speaker feature calculation unit 140 may use an average of features extracted from each of two or more sets as the first speaker features. On the other hand, when none of the sets of the first input data and the second input data is input to DNN (m′) (m′ is any one of 1 to n), the first speaker feature calculation unit 140 keeps the first speaker feature Sm′ at an initial value of 0 or a zero vector.

The first speaker feature calculation unit 140 outputs, to the second speaker feature calculation unit 150, data of the n first speaker features (S1, S2, ... Sn) calculated in this manner.

The second speaker feature calculation unit 150 receives data of n first speaker features (S1, S2, ... Sn) from the first speaker feature calculation unit 140. The second speaker feature calculation unit 150 obtains a second speaker feature by merging n pieces of first speaker features (S1, S2, ... Sn). In one example, the second speaker feature calculation unit 150 adds all the n first speaker features (S1, S2, ... Sn) to obtain the second speaker feature. In this case, the second speaker feature is (S1 + S2 + ... + Sn). Alternatively, the second speaker feature calculation unit 150 combines the n first speaker features (S1, S2, ... Sn) into one feature vector, and inputs the combined feature vector to a discriminator that has learned to verify a speaker (for example, a neural network). Then, the second speaker feature calculation unit 150 may obtain the second speaker feature from the classifier to which the merged feature vector is input.

As described above, the first speaker feature calculation unit 140 and the second speaker feature calculation unit 150 obtain the above-described first speaker features and the above-described second speaker feature.

### (Operation of Audio Processing Device 100)

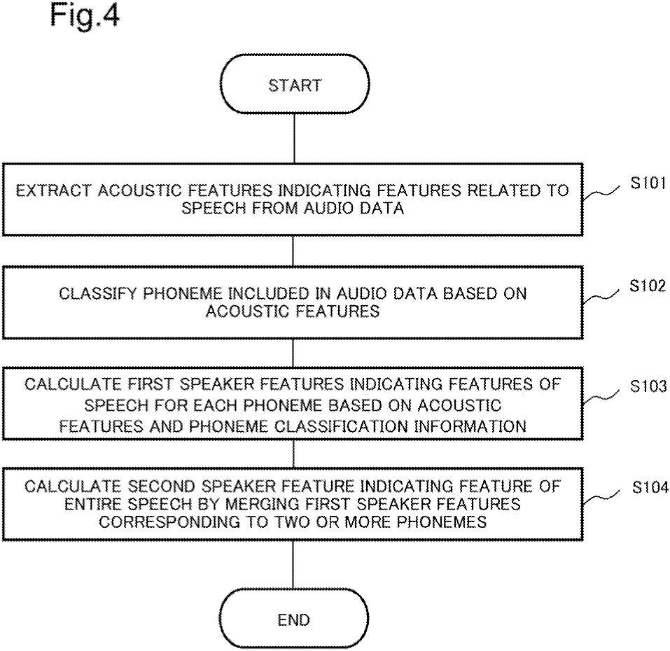

The operation of the audio processing device 100 according to the present first example embodiment will be described with reference to FIG. 4. FIG. 4 is a flowchart illustrating a flow of processing executed by each unit of the audio processing device 100.

As illustrated in FIG. 4, the acoustic feature extraction unit 130 extracts acoustic features indicating features related to the speech from the audio data (S101). The acoustic feature extraction unit 130 outputs data of the extracted acoustic features to each of the phoneme classification unit 110 and the first speaker feature calculation unit 140.

The phoneme classification unit 110 classifies phonemes included in the audio data on the basis of the acoustic features (S102). The phoneme classification unit 110 outputs the phoneme classification information indicating classification results of the phonemes included in the audio data to the first speaker feature calculation unit 140.

The first speaker feature calculation unit 140 receives data of acoustic features (F1, F2, ... FL in FIG. 3) from the acoustic feature extraction unit 130. The first speaker feature calculation unit 140 receives data of the phoneme classification information (P1, P2, ... PL in FIG. 3) from the phoneme classification unit 110.

Then, the first speaker feature calculation unit 140 calculates the first speaker features (S1, S2, ... Sn in FIG. 3) indicating the feature of a speech for each phoneme based on the received acoustic features (F1, F2, ... FL) and phoneme classification information (P1, P2, ... PL) (S103).

The first speaker feature calculation unit 140 outputs data of the first speaker features (S1, S2, ... Sn) calculated for two or more phonemes to the second speaker feature calculation unit 150.

The second speaker feature calculation unit 150 receives data of the first speaker features (S1, S2, ... Sn) from the first speaker feature calculation unit 140. The second speaker feature calculation unit 150 calculates the second speaker feature indicating a feature of the entire speech by merging the first speaker features (S1, S2, ... Sn) for two or more phonemes (S104). In one example, the second speaker feature calculation unit 150 obtains a sum of S1 to Sn (S1 + S2 + ... Sn) as the second speaker feature. The second speaker feature calculation unit 150 may obtain the second speaker feature from the first speaker features by any method other than the method described herein.

As described above, the operation of the audio processing device 100 according to the present first example embodiment ends.

In the audio authentication system 1 illustrated in FIG. 1, the audio processing device 100 calculates the first speaker features or the second speaker feature as the speaker feature A from the registered voice data illustrated in FIG. 1 according to the above-described procedure, and outputs the first speaker features or the second speaker feature to the verification device 10. The audio processing device 100 calculates the first speaker features or the second speaker feature as the speaker feature B from the voice data for verification illustrated in FIG. 1 in a similar procedure, and outputs the first speaker features or the second speaker feature to the verification device 10. The verification device 10 compares the speaker feature A based on the registered voice data with the speaker features B based on the voice data for verification, and outputs the identity confirmation result (that is, whether the person is the same person or not).

### (Modification)

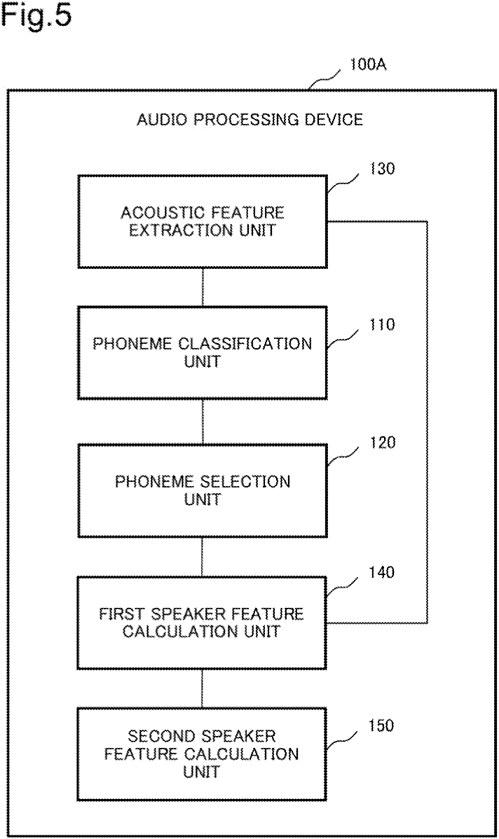

A modification of the audio processing device 100 according to the present first example embodiment will be described with reference to FIG. 5. FIG. 5 is a block diagram illustrating a configuration of an audio processing device 100A according to the present modification. As illustrated in FIG. 5, the audio processing device 100A includes a phoneme classification unit 110, a phoneme selection unit 120, an acoustic feature extraction unit 130, a first speaker feature calculation unit 140, and a second speaker feature calculation unit 150.

The phoneme selection unit 120 selects two or more phonemes among the phonemes included in the audio data according to a given condition. The phoneme selection unit 120 is an example of a phoneme selection means. In a case where the number of phonemes following a given condition is one or less among the phonemes included in the audio data, the processing described below is not performed, and the audio processing device 100A ends the operation. Next, a case where there are two or more phonemes according to a given condition among the phonemes included in the audio data will be described.

The phoneme selection unit 120 outputs the selection information indicating the two or more selected phonemes to the first speaker feature calculation unit 140.

In the present modification, the first speaker feature calculation unit 140 calculates the first speaker features indicating the feature of the speech for each phoneme on the basis of the acoustic features, the phoneme classification information indicating the verification result of the phonemes included in the audio data, and the selection information indicating two or more phonemes selected according to a given condition.

Processing performed by other components of the audio processing device 100A other than the phoneme selection unit 120 and the phoneme classification unit 110 is common to the above-described audio processing device 100.

According to the configuration of the present modification, the phoneme selection unit 120 selects two or more phonemes to be subjected to the extraction of the phoneme classification information by the phoneme classification unit 110 among the phonemes included in the audio data on the basis of a given condition. As a result, when the registered voice data and the voice data for verification are compared, a common phoneme is selected from both audio data according to a given selection condition, and the speaker feature is calculated from the phoneme classification information indicating the feature of the common phoneme. As a result, even in a case where the phrases are partially different between the voice data to be compared, the speaker verification can be performed with high accuracy based on the speaker features.

### (Effects of Present Example Embodiment)

According to the configuration of the present example embodiment, the acoustic feature extraction unit 130 extracts acoustic features indicative of features related to the speech from audio data. The phoneme classification unit 110 classifies phonemes included in the audio data on the basis of the acoustic features. The first speaker feature calculation unit 140 calculates first speaker features indicative of a feature of the speech of each phoneme on the basis of acoustic features and phoneme classification information indicative of classification results for phonemes included in the audio data. The second speaker feature calculation unit 150 calculates a second speaker feature indicative of a feature of the entire speech by merging the first speaker features regarding two or more phonemes. In this manner, the first speaker features are extracted for each phonemes. The second speaker feature is obtained by merging the first speaker features. Therefore, even when the phrases are partially different between the voice data to be compared, the speaker verification can be performed with high accuracy based on the first speaker features.

### Second Example Embodiment

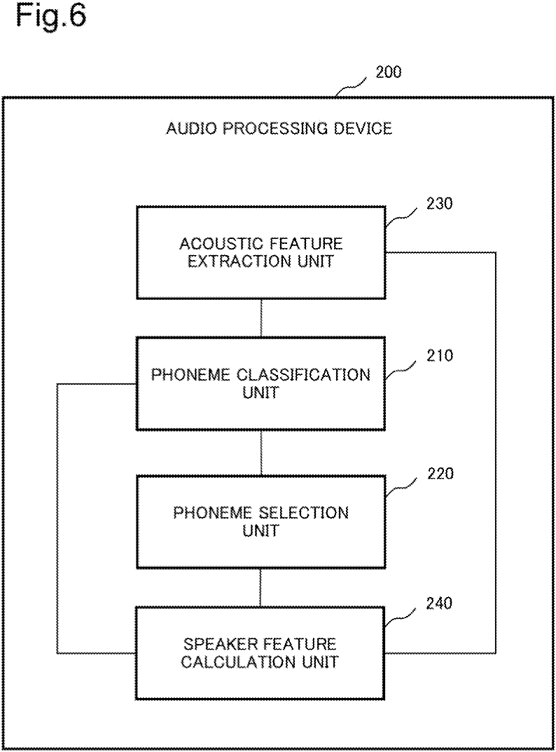

An audio processing device 200 will be described as a second example embodiment with reference to FIGS. 6 to 8.

### (Audio Processing Device 200)

A configuration of the audio processing device 200 according to the present second example embodiment will be described with reference to FIG. 6. FIG. 6 is a block diagram illustrating a configuration of the audio processing device 200. As illustrated in FIG. 6, the audio processing device 200 includes a phoneme classification unit 210, a phoneme selection unit 220, an acoustic feature extraction unit 230, and a speaker feature calculation unit 240.

The acoustic feature extraction unit 230 extracts acoustic features indicating a feature related to the speech from the audio data. The acoustic feature extraction unit 230 is an example of a phoneme classification information calculation means.

In one example, the acoustic feature extraction unit 230 acquires audio data (the voice data for verification or the registered voice data in FIG. 1) from the input device.

The acoustic feature extraction unit 230 performs fast Fourier transform on the audio data, and then extracts acoustic features from a portion of the obtained audio data. Each of the acoustic features is an N-dimensional vector.

For example, the acoustic features may be a Mel-Frequency Cepstrum Coefficients (MFCC) or a linear predictive coding (LPC) coefficient, and linear and quadratic regression coefficients thereof, or may be a formant frequency or a fundamental frequency. Alternatively, the acoustic features may be an N-dimensional feature vector (hereinafter, referred to as an acoustic vector) including a feature amount obtained by frequency analysis of audio data. In one example, the acoustic vector indicates a frequency characteristic of audio data input from an input device.

The acoustic feature extraction unit 230 outputs the data of the acoustic features extracted from the audio data in this manner to each of the phoneme classification unit 210 and the speaker feature calculation unit 240.

The phoneme classification unit 210 classifies phonemes included in the audio data on the basis of the acoustic features. The phoneme classification unit 210 is an example of a phoneme classification means. In one example, the phoneme classification unit 210 uses a well-known hidden Markov model or neural network to classify a corresponding phoneme by using data of the acoustic features per unit time. Then, the phoneme classification unit 210 combines M likelihoods or posterior probabilities that are classification results of phonemes to generate an M-dimensional phoneme vector. In one example, M matches the number of phonemes included in a particular language (the language that is assumed to have been spoken), or the number of portions of phonemes (e.g., only vowel sound).

The phoneme classification unit 210 repeats generation of a phoneme vector indicating a single phoneme every unit time as described above. As a result, the phoneme classification unit 210 generates the time-series data (P1, P2, ... PL) of the length L (L is an integer of 2 or more) including the phoneme vector (P1 to PL) indicating the classified phoneme. The time-series data (P1, P2, ... PL) of the length L indicates the phonemes classified by the phoneme classification unit 210. The phoneme vectors (P1 to PL) are hereinafter referred to as phoneme classification information. Each of the phoneme classification information P1 to PL indicates one of n phonemes (n is an integer of 2 or more) in a specific language.

The phoneme classification unit 210 outputs phoneme classification information for classifying the phonemes classified by the phoneme classification unit 210 to the phoneme selection unit 220 and the speaker feature calculation unit 240.

The phoneme selection unit 220 selects a phoneme according to a given selection condition among phonemes included in the audio data. The phoneme selection unit 220 is an example of a phoneme selection means. A specific example of a given selection condition will be described in the following example embodiment. Then, the phoneme selection unit 220 outputs selection information indicating a phoneme selected according to a given condition to the speaker feature calculation unit 240.

The speaker feature calculation unit 240 calculates the speaker feature indicating the feature of the speech of the speaker on the basis of the acoustic features, the phoneme classification information indicating the verification result of the phonemes included in the audio data, and the selection information indicating the phonemes selected according to a given condition. The speaker feature calculation unit 240 is an example of a speaker feature calculation means.

In one example, the speaker feature calculation unit 240 extracts a phoneme selected according to a given condition among the phonemes included in the audio data on the basis of the selection information. Specifically, the speaker feature calculation unit 240 selects K (K is 0 or more and L or less) phonemes (hereinafter, P′1 to P′K) selected by the phoneme selection unit 220 among the L phonemes classified by the phoneme classification information P1 to PL. When K = 0, the speaker feature calculation unit 240 does not calculate the speaker feature. Alternatively, the speaker feature calculation unit 240 inputs only the acoustic features to the DNN. Hereinafter, a case where K is 1 or more and L or less will be described.

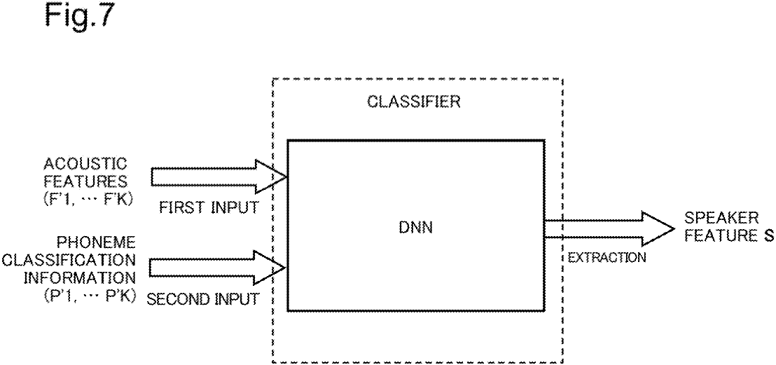

The speaker feature calculation unit 240 calculates the speaker features (S in FIG. 7) on the basis of each piece of phoneme classification information (P′1, ... P′K in FIG. 7) for the selected K (K is 1 or more and L or less) phonemes and acoustic features ((F′1 ... F′K in FIG. 7)).

For example, the speaker feature calculation unit 240 can calculate the speaker feature by combining the phoneme classification information and the acoustic features using the method described in NPL 1 and inputting the phoneme classification information and the acoustic features to the classifier. The speaker feature indicates a feature of the speaker’s speech. A specific example in which the speaker feature calculation unit 240 calculates the speaker feature using the classifier (FIG. 7) will be described later.

The speaker feature calculation unit 240 outputs the data of the speaker feature thus calculated to the verification device 10 (FIG. 1). Further, the speaker feature calculation unit 240 may transmit the data of the speaker feature to a device other than the verification device 10.

### (Speaker Features)

FIG. 7 is an explanatory diagram illustrating an outline of processing in which the speaker feature calculation unit 240 calculates a speaker feature using a classifier. As illustrated in FIG. 7, the classifier includes a DNN.

Before the phase for the speaker feature calculation unit 240 to calculate the speaker feature, the DNN completes the deep learning so that the speaker can be verified based on the acoustic features (F′1 to F′K in FIG. 7) as the first input and the phoneme classification information (P′1 to P′K in FIG. 7) as the second input.

Specifically, in the deep learning phase, the speaker feature calculation unit 240 inputs the teacher data to the DNN, and updates each parameter of the DNN so that the output result from the DNN and the correct answer of the verification result of the teacher data are brought close to each other (that is, the correct answer rate is improved). The speaker feature calculation unit 240 repeats the processing of updating each parameter of the DNN until a predetermined number of times or an index value representing a difference between the output result from the DNN and the correct answer falls below a threshold. This completes training of the DNN.

The speaker feature calculation unit 240 inputs one acoustic feature (one of F′1 to F′K) as the first input data to the rained DNN (hereinafter, it is simply referred to as DNN), and inputs one piece of the phoneme classification information (one of P′1 to P′K) as the second input data.

In one example, each of the K acoustic features (F′1 to F′K) is an N-dimensional feature vector, and each of the K phoneme classification information (P′1 to P′K) is an M-dimensional feature vector. The N-dimension and the M-dimension may be the same or different.

More specifically, the speaker feature calculation unit 240 generates M + N dimensional acoustic feature F″k by extending one acoustic feature F′k (k is 1 or more and K or less) by M dimensions, and all the extended M-dimensional elements are empty. Then, the speaker feature calculation unit 240 sets the element of the phoneme classification information P′k as an M-dimensional element of the acoustic feature F″k. In this case, the first input data and the second input data are combined, and the M + N dimensional acoustic feature F″k is input to the DNN. Then, the speaker feature calculation unit 240 extracts the speaker feature S from the intermediate layer of the DNN to which the first input data and the second input data are input.

As described above, the speaker feature calculation unit 240 obtains the speaker feature S indicating the feature of the speech of the speaker.

### (Operation of Audio Processing Device 200)

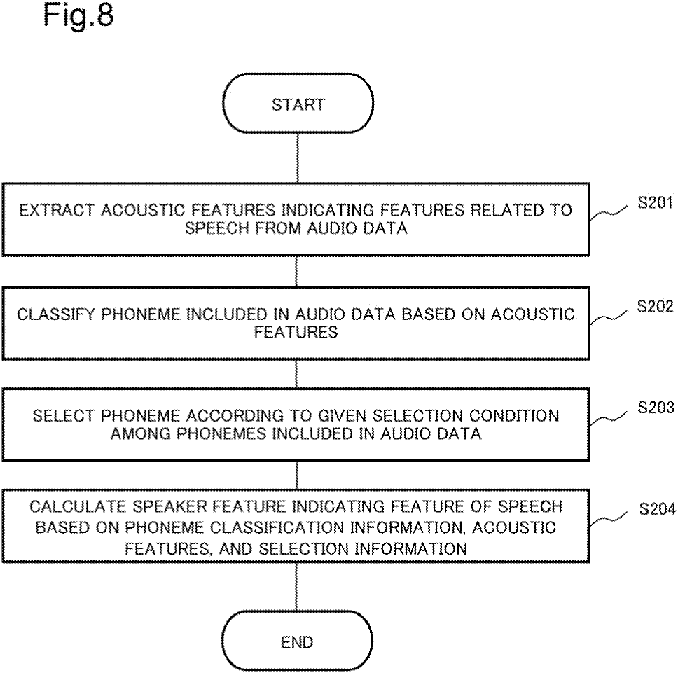

The operation of the audio processing device 200 according to the present second example embodiment will be described with reference to FIG. 8. FIG. 8 is a flowchart illustrating a flow of processing executed by each unit of the audio processing device 200.

As illustrated in FIG. 8, the acoustic feature extraction unit 230 extracts acoustic features indicating features related to the speech from the audio data (S201). The acoustic feature extraction unit 230 outputs data of the extracted acoustic features to each of the phoneme classification unit 210 and the speaker feature calculation unit 240.

The phoneme classification unit 210 classifies phonemes included in the audio data on the basis of the acoustic features (S202). The phoneme classification unit 210 outputs the verification result of the phonemes included in the audio data to the phoneme selection unit 220 and the speaker feature calculation unit 240.

The phoneme selection unit 220 selects a phoneme according to a given selection condition among phonemes included in the audio data (S203). The phoneme selection unit 220 outputs the selection information indicating the selected phonemes to the speaker feature calculation unit 240.

The speaker feature calculation unit 240 receives data of acoustic features (F′1 to F′K in FIG. 7) from the acoustic feature extraction unit 230. The speaker feature calculation unit 240 receives, from the phoneme classification unit 210, the phoneme classification information (P′1 to P′K in FIG. 7) for classifying phonemes included in the audio data. In addition, the speaker feature calculation unit 240 receives the selection information indicating the selected phoneme from the phoneme selection unit 220.

The speaker feature calculation unit 240 calculates speaker features (S in FIG. 7) indicating features of the speaker’s speech on the basis of the acoustic features, the phoneme classification information indicating the verification result of the phonemes included in the audio data, and the selection information indicating the phonemes selected according to a given condition (S204).

The speaker feature calculation unit 240 outputs the calculated speaker feature data to the verification device 10 (FIG. 1).

As described above, the operation of the audio processing device 200 according to the present second example embodiment ends.

In the audio authentication system 1 illustrated in FIG. 1, the audio processing device 200 calculates speaker features (speaker features (A, B) in FIG. 1) from the registered voice data and the voice data for verification illustrated in FIG. 1 according to the above-described procedure, and outputs the speaker features to the verification device 10. The verification device 10 compares the speaker feature A based on the registered voice data with the speaker features B based on the voice data for verification, and outputs the identity confirmation result (that is, whether the person is the same person or not).

### (Effects of Present Example Embodiment)

According to the configuration of the present example embodiment, the acoustic feature extraction unit 230 extracts the acoustic features indicating the feature related to the speech from the audio data. The phoneme classification unit 210 classifies phonemes included in the audio data on the basis of the acoustic features. The phoneme selection unit 220 selects a phoneme according to a given selection condition among phonemes included in the audio data. The speaker feature calculation unit 240 calculates the speaker feature indicating the feature of the speech of the speaker on the basis of the acoustic features, the phoneme classification information indicating the verification result of the phonemes included in the audio data, and the selection information indicating the phonemes selected according to a given condition. Therefore, when the registered voice data and the voice data for verification are compared, a common phoneme is selected from both audio data according to a given selection condition, and the speaker feature is calculated based on the selection information indicating the phoneme selected according to the given condition in addition to the acoustic features and the phoneme classification information. As a result, even in a case where the phrases are partially different between the voice data to be compared, the speaker verification can be performed with high accuracy based on the speaker features.

### Third Example Embodiment

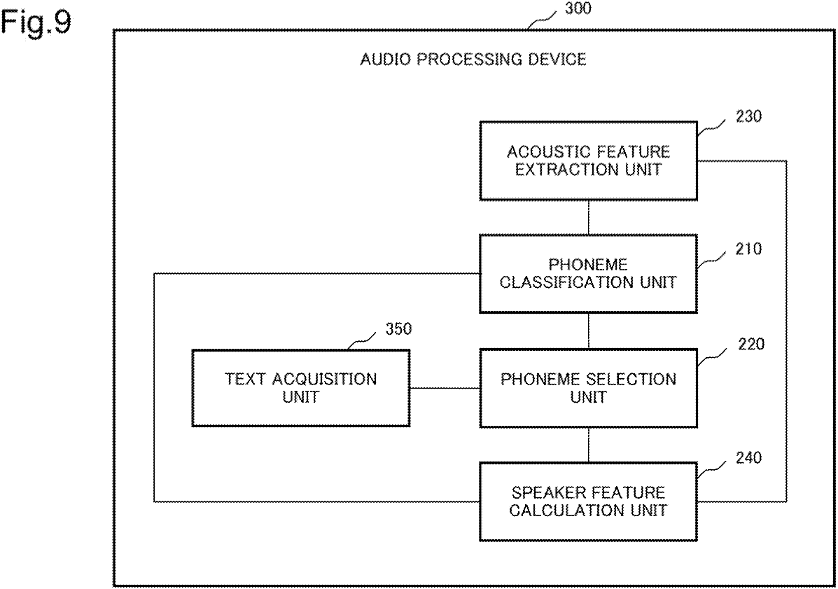

With reference to FIG. 9, an audio processing device 300 will be described as a third example embodiment. In the present third example embodiment, the phoneme selection unit 220 selects two or more phonemes that are the same as two or more phonemes included in the registered voice data among the phonemes included in the audio data.

### (Audio Processing Device 300)

A configuration of an audio processing device 300 according to the present third example embodiment will be described with reference to FIG. 9. FIG. 9 is a block diagram illustrating a configuration of the audio processing device 300. As illustrated in FIG. 9, the audio processing device 300 includes a phoneme classification unit 210, a phoneme selection unit 220, an acoustic feature extraction unit 230, and a speaker feature calculation unit 240. In addition, the audio processing device 300 further includes a text acquisition unit 350.

The text acquisition unit 350 acquires data of a predetermined text prepared in advance. The text acquisition unit 350 is an example of a text acquisition means. The data of the predetermined text may be stored in a text DB (not illustrated). Alternatively, the data of the predetermined text may be input by an input device and stored in a temporary storage unit (not illustrated). The text acquisition unit 350 outputs the data of the predetermined text to the phoneme selection unit 220.

In the present third example embodiment, the phoneme selection unit 220 receives data of a predetermined text from the text acquisition unit 350. Then, the phoneme selection unit 220 selects a phoneme corresponding to one or more characters included in the predetermined text among phonemes included in the audio data. In one example, the phoneme selection unit 220 selects a phoneme on the basis of a table indicating a correspondence between a phoneme and a character.

The description of the second example embodiment will be cited with respect to the components of the audio processing device 300 other than the phoneme selection unit 220 and the text acquisition unit 350, and the description of the third example embodiment will be omitted.

### (Effects of Present Example Embodiment)

According to the configuration of the present example embodiment, the acoustic feature extraction unit 230 extracts the acoustic features indicating the features related to the speech from the audio data. The phoneme classification unit 210 classifies phonemes included in the audio data on the basis of the acoustic features. The phoneme selection unit 220 selects a phoneme according to a given selection condition among phonemes included in the audio data. The speaker feature calculation unit 240 calculates the speaker feature indicating the feature of the speech of the speaker on the basis of the acoustic features, the phoneme classification information indicating the verification result of the phonemes included in the audio data, and the selection information indicating the phonemes selected according to a given condition. Therefore, when the registered voice data and the voice data for verification are compared, a common phoneme is selected from both audio data according to a given selection condition, and the speaker feature is calculated based on the selection information indicating the phoneme selected according to the given condition in addition to the acoustic features and the phoneme classification information. As a result, even in a case where the phrases are partially different between the voice data to be compared, the speaker verification can be performed with high accuracy based on the speaker features.

Further, according to the configuration of the present example embodiment, the text acquisition unit 350 acquires data of a predetermined text prepared in advance. The phoneme selection unit 220 selects a phoneme corresponding to one or more characters included in the predetermined text among phonemes included in the audio data. Therefore, the speaker verification can be easily performed with high accuracy by causing the speaker to read out all or a part of the predetermined text.

### Fourth Example Embodiment

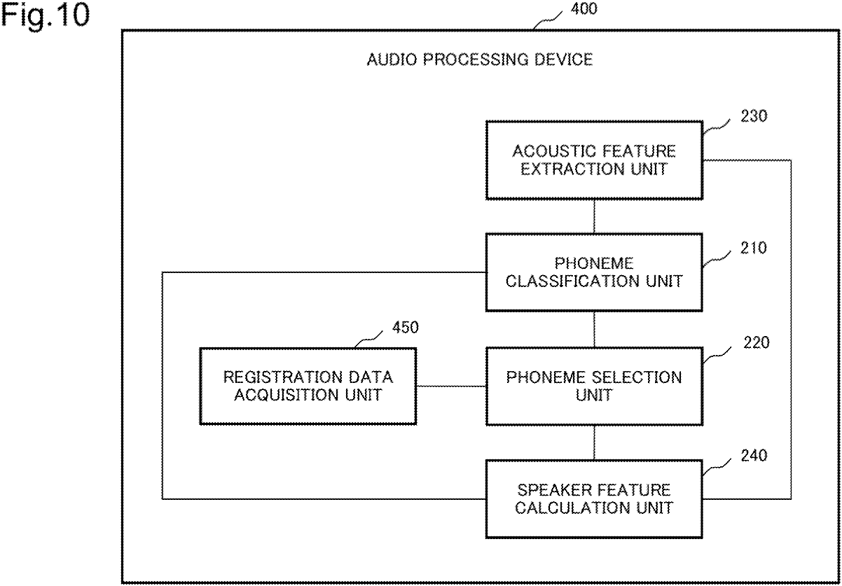

With reference to FIG. 10, an audio processing device 400 will be described as a fourth example embodiment. In the fourth example embodiment, the phoneme selection unit 220 selects two or more phonemes corresponding to two or more characters included in the predetermined text among the phonemes included in the audio data.

### (Audio Processing Device 400)

A configuration of an audio processing device 400 according to the present fourth example embodiment will be described with reference to FIG. 10. FIG. 10 is a block diagram illustrating a configuration of the audio processing device 400. As illustrated in FIG. 10, the audio processing device 400 includes a phoneme classification unit 210, a phoneme selection unit 220, an acoustic feature extraction unit 230, and a speaker feature calculation unit 240. In addition, the audio processing device 400 further includes a registration data acquisition unit 450.

The registration data acquisition unit 450 acquires the registered voice data. The registration data acquisition unit 450 is an example of a registration data acquisition means. In one example, the registration data acquisition unit 450 acquires registered voice data (registered voice data in FIG. 1) from a DB (FIG. 1). The registration data acquisition unit 450 outputs the registered voice data to the phoneme selection unit 220.

In the present fourth example embodiment, the phoneme selection unit 220 receives the registered voice data from the registration data acquisition unit 450. Then, the phoneme selection unit 220 selects the same phoneme as one or more phonemes included in the registered voice data among the phonemes included in the audio data.

The description of the second example embodiment will be cited with respect to the components of the audio processing device 400 other than the phoneme selection unit 220 and the registration data acquisition unit 450, and the description of the fourth example embodiment will be omitted.

### (Effects of Present Example Embodiment)

According to the configuration of the present example embodiment, the acoustic feature extraction unit 230 extracts the acoustic features indicating the features related to the speech from the audio data. The phoneme classification unit 210 classifies phonemes included in the audio data on the basis of the acoustic features. The phoneme selection unit 220 selects a phoneme according to a given selection condition among phonemes included in the audio data. The speaker feature calculation unit 240 calculates the speaker feature indicating the feature of the speech of the speaker on the basis of the acoustic features, the phoneme classification information indicating the verification result of the phonemes included in the audio data, and the selection information indicating the phonemes selected according to a given condition. Therefore, when the registered voice data and the voice data for verification are compared, a common phoneme is selected from both audio data according to a given selection condition, and the speaker feature is calculated based on the selection information indicating the phoneme selected according to the given condition in addition to the acoustic features and the phoneme classification information. As a result, even in a case where the phrases are partially different between the voice data to be compared, the speaker verification can be performed with high accuracy based on the speaker features.

Further, according to the configuration of the present example embodiment, the registration data acquisition unit 450 acquires registered voice data. The phoneme selection unit 220 selects the same phoneme as one or more phonemes included in the registered voice data among the phonemes included in the audio data. Therefore, by causing the speaker to utter the same or partially equal phrase or sentence between the time of registration and the time of verification, the speaker verification can be easily performed with high accuracy.

### Hardware Configuration

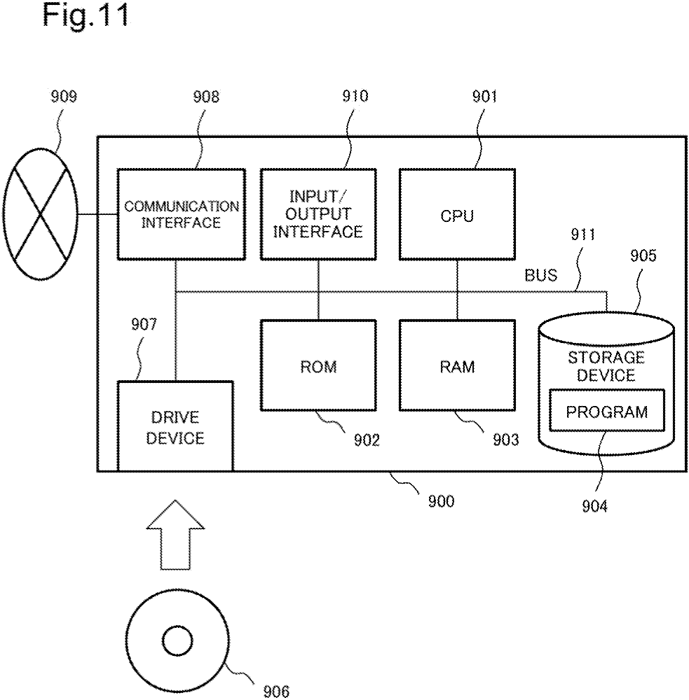

Each component of the audio processing devices 100 (100A), 200, 300, and 400 described in the first to fourth example embodiments indicates a block of a functional unit. Some or all of these components are implemented by an information processing device 900 as illustrated in FIG. 11, for example. FIG. 11 is a block diagram illustrating an example of a hardware configuration of the information processing device 900.

As illustrated in FIG. 11, the information processing device 900 includes the following configuration as an example.

· CPU (Central Processing Unit) 901
· ROM (Read Only Memory) 902
· RAM (Random Access Memory) 903
· Program 904 loaded into RAM 903
· Storage device 905 storing program 904
· Drive device 907 that reads and writes recording medium 906
· Communication interface 908 connected to communication network 909
· Input/output interface 910 for inputting/outputting data
· Bus 911 connecting each component

The components of the audio processing device 100 (100A), 200, 300, and 400 described in the first to fourth example embodiments are implemented by the CPU 901 reading and executing the program 904 that implements these functions. The program 904 for achieving the function of each component is stored in the storage device 905 or the ROM 902 in advance, for example, and the CPU 901 loads the program into the RAM 903 and executes the program as necessary. The program 904 may be supplied to the CPU 901 via the communication network 909, or may be stored in advance in the recording medium 906, and the drive device 907 may read the program and supply the program to the CPU 901.

According to the above configuration, the audio processing device 100(100A), 200, 300, and 400 described in the first to fourth example embodiments are achieved as hardware. Therefore, an effect similar to the effect described in any one the first to fourth example embodiments can be obtained.

### Supplementary Notes

Some or all of the above example embodiments may be described as the following supplementary notes, but are not limited to the following.

### (Supplementary Note 1)

An audio processing device including:
an acoustic feature extraction means configured to extract acoustic features indicating features related to a speech from audio data;
a phoneme classification means configured to classify a phoneme included in the audio data based on the acoustic features;
a first speaker feature calculation means configured to calculate first speaker features indicating features of a speech for each phoneme based on the acoustic features and phoneme classification information indicating classification results of the phonemes included in the audio data; and
a second speaker feature calculation means configured to calculate a second speaker feature indicating a feature of an entire speech by merging the first speaker features for each of two or more phonemes.

### (Supplementary Note 2)

The audio processing device according to Supplementary Note 1, further including:
a phoneme selection means configured to select two or more phonemes among the phonemes included in the audio data according to a given condition, in which
the first speaker feature calculation means calculates a speaker feature indicating features of a speech based on the acoustic features, phoneme classification information indicating a verification result of two or more phonemes included in the audio data, and selection information indicating two or more phonemes selected according to the given condition.

### (Supplementary Note 3)

The audio processing device according to Supplementary Note 2, in which

the phoneme selection means selects two or more phonemes that are a same as two or more phonemes included in registered voice data from among phonemes included in the audio data.

### (Supplementary Note 4)

The audio processing device according to Supplementary Note 2, in which

the phoneme selection means selects two or more phonemes corresponding to two or more characters included in a predetermined text from among phonemes included in the audio data.

### (Supplementary Note 5)

The audio processing device according to any one of Supplementary Notes 1 to 4, in which
the first speaker feature calculation means is configured to:
   calculate the first speaker features for each set of the acoustic features and phoneme classification information extracted from a single phoneme, and
the second speaker feature calculation means is configured to:
   calculate a second speaker feature indicating a feature of the entire speech by adding the first speaker features calculated for a plurality of the sets.

### (Supplementary Note 6)

An audio processing device including:
an acoustic feature extraction means configured to extract acoustic features indicating a feature related to a speech from audio data;
a phoneme classification means configured to classify a phoneme included in the audio data based on the acoustic features;
a phoneme selection means configured to select a phoneme according to a given selection condition among phonemes included in the audio data; and
a speaker feature calculation means configured to calculate a speaker feature indicating features of a speech based on the acoustic features, phoneme classification information indicating a verification result of a phoneme included in the audio data, and selection information indicating a phoneme selected according to the given condition.

### (Supplementary Note 7)

The audio processing device according to Supplementary Note 6, further including:
a text acquisition means configured to acquire data of a predetermined text prepared in advance, in which
the phoneme selection means selects a phoneme corresponding to one or more characters included in the predetermined text among phonemes included in the audio data.

### (Supplementary Note 8)

The audio processing device according to Supplementary Note 6, further including:
a registration data acquisition means configured to acquire registered voice data, in which
the phoneme selection means selects a same phoneme as one or more phonemes included in the registered voice data among phonemes included in the audio data.

### (Supplementary Note 9)

An audio processing method including:
extracting acoustic features indicating a feature related to a speech from audio data;
classifying a phoneme included in the audio data based on the acoustic features;
generating first speaker features indicating features of a speech for each phoneme based on the acoustic features and phoneme classification information indicating a verification result of a phoneme included in the audio data; and
generating a second speaker feature indicating a feature of an entire speech by merging the first speaker features for each of two or more phonemes.

### (Supplementary Note 10)

A non-transitory recording medium storing a program for causing a computer to execute:
extracting acoustic features indicating a feature related to a speech from audio data;
classifying a phoneme included in the audio data based on the acoustic features;
generating first speaker features indicating features of a speech for each phoneme based on the acoustic features and phoneme classification information indicating a verification result of a phoneme included in the audio data; and
generating a second speaker feature indicating a feature of an entire speech by merging the first speaker features for each of the two or more phonemes.

### (Supplementary Note 11)

An audio processing method including:
extracting acoustic features indicating a feature related to a speech from audio data;
classifying a phoneme included in the audio data based on the acoustic features;
selecting a phoneme according to a given selection condition among phonemes included in the audio data; and
generating a speaker feature indicating features of a speech based on the acoustic features, phoneme classification information indicating a verification result of a phoneme included in the audio data, and selection information indicating a phoneme selected according to the given condition.

### (Supplementary Note 12)

A non-transitory recording medium storing a program for causing a computer to execute:
extracting acoustic features indicating features related to a speech from audio data;
classifying a phoneme included in the audio data based on the acoustic features;
selecting a phoneme according to a given selection condition among phonemes included in the audio data; and
generating a speaker feature indicating features of a speech based on the acoustic features, phoneme classification information indicating a verification result of a phoneme included in the audio data, and selection information indicating a phoneme selected according to the given condition.

### (Supplementary Note 13)

An audio authentication system including:
the audio processing device according to any one of Supplementary Notes 1 to 5; and
a verification device configured to verify whether a speaker is a registered person himself/herself based on the first speaker features or the second speaker feature calculated by the audio processing device.

### (Supplementary Note 14)

An audio authentication system including:
the audio processing device according to any one of Supplementary Notes 6 to 8; and
a verification device configured to confirm whether a speaker is a registered person himself/herself based on the speaker feature calculated by the audio processing device.

### INDUSTRIAL APPLICABILITY

In one example, the present disclosure can be used in an audio authentication system that performs verification by analyzing audio data input using an input device.

Reference signs List

| | |
|---|---|
| 1 | audio authentication system |
| 10 | verification device |
| 100 | audio processing device |
| 100A | audio processing device |
| 110 | phoneme classification unit |
| 120 | phoneme selection unit |
| 130 | acoustic feature extraction unit |
| 140 | first speaker feature calculation unit |
| 150 | second speaker feature calculation unit |
| 200 | audio processing device |
| 210 | phoneme classification unit |
| 220 | phoneme selection unit |
| 230 | acoustic feature extraction unit |
| 240 | speaker feature calculation unit |
| 300 | audio processing device |
| 350 | text acquisition unit |
| 400 | audio processing device |
| 450 | registration data acquisition unit |

What is claimed is:

1. An audio processing device comprising:
a memory configured to store instructions; and
at least one processor configured to execute the instructions to perform:
extracting acoustic features indicating features related to a speech from audio data;
classifying phonemes included in the audio data based on the acoustic features;
generating first speaker features indicating features of a speech for each phoneme based on the acoustic features and phoneme classification information indicating classification results of phonemes included in the audio data; and
generating a second speaker feature indicating a feature of an entire speech by merging the first speaker features for each of two or more phonemes.

2. The audio processing device according to claim 1, wherein
the at least one processor is configured to execute the instructions to perform:
selecting two or more phonemes among the phonemes included in the audio data according to a given condition, wherein
the at least one processor is configured to execute the instructions to perform:
generating a speaker feature indicating features of a speech based on the acoustic features, phoneme classification information indicating classification results of two or more phonemes included in the audio data, and selection information indicating two or more phonemes selected according to the given condition.

3. The audio processing device according to claim 2, wherein
the at least one processor is configured to execute the instructions to perform:
selecting two or more phonemes that are a same as two or more phonemes included in registered audio data among phonemes included in the audio data.

4. The audio processing device according to claim 2, wherein
the at least one processor is configured to execute the instructions to perform:
selecting two or more phonemes corresponding to two or more characters included in a predetermined text among phonemes included in the audio data.

5. The audio processing device according to claim 1, wherein
the at least one processor is configured to execute the instructions to perform:
generating the first speaker features for each set of the acoustic features and phoneme classification information extracted from a single phoneme, and
generating a second speaker feature indicating a feature of the entire speech by adding the first speaker features generated for a plurality of the sets.

6. (canceled)

7. (canceled)

8. (canceled)

9. An audio processing method comprising:
extracting acoustic features indicating features related to a speech from audio data;
classifying phonemes included in the audio data based on the acoustic features;
generating first speaker features indicating features of a speech for each phoneme based on the acoustic features and phoneme classification information indicating classification results of the phonemes included in the audio data; and
generating a second speaker feature indicating a feature of an entire speech by merging the first speaker features for each of two or more phonemes.

10. A non-transitory recording medium storing a program for causing a computer to execute:
extracting acoustic features indicating features related to a speech from audio data;
classifying phonemes included in the audio data based on the acoustic features;
generating first speaker features indicating features of a speech for each phoneme based on the acoustic features and phoneme classification information indicating classification results of the phonemes included in the audio data; and
generating a second speaker feature indicating a feature of an entire speech by merging the first speaker features for each of the two or more phonemes.

11. (canceled)

12. (canceled)

13. (canceled)

14. (canceled)
